(19) United States
(12) Patent Application Publication
(10) Pub. No.: US 2013/0023436 A1
(43) Pub. Date: Jan. 24, 2013

(54) DISEASE DIAGNOSIS AND TREATMENT USING COMPUTATIONAL MOLECULAR PHENOTYPING

(71) Applicants: Bryan William Jones, Salt Lake City, UT (US); Greg Jones, Salt Lake City, UT (US); Charles Keller, Portland, OR (US); Marguerite Shaw, Salt Lake City, UT (US); James Anderson, Corvallis, OR (US); Robert E. Marc, Salt Lake City, UT (US)

(72) Inventors: Bryan William Jones, Salt Lake City, UT (US); Greg Jones, Salt Lake City, UT (US); Charles Keller, Portland, OR (US); Marguerite Shaw, Salt Lake City, UT (US); James Anderson, Corvallis, OR (US); Robert E. Marc, Salt Lake City, UT (US)

(21) Appl. No.: 13/521,853

(22) PCT Filed: Jan. 11, 2011
(86) PCT No.: PCT/US11/20805

§ 371 Date: Oct. 9, 2012

Related U.S. Application Data
(60) Provisional application No. 61/295,373, filed on Jan. 15, 2010.

(51) Int. Cl. C40B 30/04

(52) U.S. Cl. 506/9

(57) ABSTRACT

Disclosed are methods for detecting the presence or absence of disease in subjects based, at least in part, on results of analysis of a sample using computational molecular phenotyping. Further disclosed herein are methods for monitoring the status of subjects diagnosed with disease based at least partially on results of computational molecular phenotyping. The test samples disclosed herein are represented by, but not limited in anyway to, biopsy samples of body tissue.

### TECHNICAL FIELD

The present technology relates generally to the fields of molecular biology and pharmacology and to the diagnosis, prognosis or prevention/therapeutic treatment of disease. The technology further relates to screening methods for identifying biomarkers that are associated with disease.

### BACKGROUND

The following description is provided to assist the understanding of the reader. None of the information provided or references cited is admitted to be prior art to the present invention.

Metabolomics is an emerging field that provides critical insight into the physiologic status of cells by identifying and quantifying multiple cellular metabolites. As a complement to genomics, proteomics, and transcriptomics, metabolomics has been successful in discriminating a wide variety of different metabolic phenotypes where more conventional assessments have failed. Through assessment of alterations in the profiles of metabolites, new insights into disease processes have already been made.

Small molecules found in living systems include, for example, carbohydrates (sugars), alkyl and cyclic alcohols, polyenes, alkaloids, glycosides, flavonoids, carboxylates, lipids (e.g. fatty acids), amines, amino acids, cofactors and vitamins, steroids and terpenes, nucleobases and their derivatives (nucleosides and nucleotides), pyrroles, phenazines, antibiotics (e.g. polyketides, polypeptides and aminoglycosides), small oligomers (glutathione, sucrose, and neurohormonal peptides) and various intermediates of metabolic and signaling pathways. Sugars are a primary source of chemical energy for many cells via reactions that anaerobically/aerobically charge trinucleotide phosphates and reduce dinucleotide cofactors as collateral events in carbohydrate metabolism. Fatty acids are used for energy storage and major components of cell membranes. Amino acids are the building blocks of proteins, key intermediates in virtually every biosynthetic pathway. Large pools of certain amino acids and amines are maintained for signaling; group transfer in lipid, nucleic acid, and other amine and carboxylate biosynthetic pathways; osmoregulation; redox control; reactive oxygen species control; and bioenergetics regulation. Nucleotides are involved in intracellular signaling, energy transfer, metabolic regulation (especially allosteric control) and are the energetically charged storage forms for the nucleobase monomers of the information macromolecules, tRNA, mRNA, rRNA and DNA.

Synthesis and metabolism occurs through sequences of controlled chemical reactions, catalyzed by enzymes. Metabolomics approaches may be used to monitor both rapid and slow systemic physiological changes and provide information for the diagnosis, prediction, prevention and monitoring of many genetic, infectious and environmental diseases.

### SUMMARY

This technology relates generally to analytical testing of samples, and to aspects of biomarker elucidation for the diagnosis, prognosis, or prevention/therapeutic treatment of disease.

In one aspect, the present disclosure provides a method for identifying a therapeutic target for the treatment of a disease, the method comprising: (a) obtaining a small molecule profile by computational molecular phenotyping (CMP) from a diseased tissue obtained from a subject; (b) obtaining a CMP profile from a reference tissue; and (c) determining whether the CMP profile measured for the diseased tissue is different than the CMP profile from the reference tissue to detect one or more metabolic aberrancies in the diseased tissue, wherein the one or more metabolic aberrancies are a therapeutic target for the treatment of disease.

In one embodiment, the diseased tissue is a biopsy from a cancer tissue. In one embodiment, the cancer tissue is selected from the group consisting of: carcinoma of the bladder, breast, colon, kidney, liver, lung, esophagus, gall-bladder, ovary, pancreas, stomach, cervix, thyroid, prostate, and skin; small cell lung cancer; squamous cell carcinoma; fibrosarcoma; rhabdomyosarcoma; astrocytoma; neuroblastoma; glioma; schwannoma; melanoma; seminoma; teratocarcinoma; osteosarcoma; xenoderoma pigmentosum; keratoctanthoma; thyroid follicular cancer; Ewing's sarcoma; and Kaposi's sarcoma.

In one embodiment, the reference tissue is a normal tissue, a tissue before or after a treatment, or a tissue before or after a disease or a stage of disease. In one embodiment, the reference tissue is a normal tissue. In one embodiment, the diseased tissue and the reference tissue are obtained from the same subject. In one embodiment, the reference tissue is obtained from one subject and the diseased tissue is obtained from another subject. In one embodiment, the reference tissue comprises a tissue that has not been treated with a therapeutic agent.

In one embodiment, the one or more metabolic aberrancies results from a cellular response selected from the group consisting of: improperly distributed anaerobic metabolism, abnormal cell growth (hypertrophy), abnormal tissue growth (hyperplasia), apoptosis, cytoskeletal remodeling, altered extracellular matrix regulation, altered microfluidics (changes in coupling and adhesion), altered gene transcription, motility, differentiation, transformation, proliferation, altered signaling, inflammation or angiogenesis. In an exemplary embodiment, the one or more metabolic aberrancies is the Warburg effect.

In one embodiment, obtaining a CMP profile comprises: (i) trapping metabolites in tissues; (ii) producing an array of tissue sections; (iii) contacting the array of tissue sections with a plurality of labeled probes for one or more metabolites; (iv) imaging the tissue sections in the array to detect signals from the plurality of labeled probes; (v) creating a mosaic of the images from the array and registering the signals from the plurality of labeled probes into a multispectral data set; and (vi) analyzing the multi channel data set in N-dimensional data spaces using pattern recognition in order to generate a theme map representative of distinctive metabolites in a cell population within the tissue section. In one embodiment, obtaining a CMP profile further comprises (vii) displaying a visual indication of the theme maps or N-dimensional plot to visually indicate the distinctive metabolites in each cell population within the tissue section.

In one embodiment, the plurality of labeled probes are hapten-specific IgG reagents. In one embodiment, the plurality of labeled probes are specific for one or more metabolites selected from the group consisting of: L-alanine, ADP, allantoin, allantoate, aminophosphonobutyrate, ATP, AGB, beta-alanine, L-Cysteine, cyclic AMP, cyclic GMP, D-aspartate, L-aspartate, dopamine, D-glutamate, L-glutamate, L-phenylalanine, glycine, D-glucosamine, carboxyglutamate, guanidinium, guanidoacetate, L-histidine, L-isoleucine, glutathione, L-lysine, L-leucine, L-lactic acid, L-methionine, L-asparagine, norepinephrine, L-ornithine, 2-oxoglutarate, L-proline, L-4-hydroxyproline, D-glutamine, L-glutamine, D-arginine, L-arginine, L-serine, serotonin, L-threonine, taurine, L-valine, L-tryptophan, L-citrulline, L-tyrosine, and GABA. Other metabolites may be included. In one embodiment, the plurality of labeled probes are specific for one or more metabolites selected from the group consisting of: agmatine (1-amino, 4-guanidino butyrate), alanine, 4-aminobutyrate, arginine, aspartate, ATP, ADP, citrulline, cysteine, glutamate, glutamine, glutathione, glucosamine, glycine, guanidoacetate, ornithine, proline, phenylalanine, serine, taurine, threonine, and tyrosine.

In one embodiment, detecting one or more metabolic aberrancies in the diseased tissue comprises correlating features between the CMP of the diseased tissue and the CMP of the reference tissue to determine one or more sets of differences and generating a profile of one or more metabolic aberrancies in response to one or more correlations.

In another aspect, the present disclosure provides a method for identifying biomarkers associated with a disease, the method comprising: (a) obtaining a computational molecular phenotype (CMP) profile from a diseased tissue obtained from a subject; (b) obtaining a CMP profile from a reference tissue; and (c) determining whether the CMP profile measured for the diseased tissue is different than the CMP profile from the reference cell to detect one or more metabolic aberrancies in the diseased tissue, wherein the one or more metabolic aberrancies are a biomarker for a disease.

In another aspect, the present disclosure provides a method for selecting one or more therapeutic agents for the treatment of a disease, the method comprising: (a) obtaining a computational molecular phenotype (CMP) profile from a diseased tissue obtained from a subject; (b) obtaining a CMP profile from a reference tissue; (c) determining whether the CMP profile measured for the diseased tissue is different than the CMP profile from the reference tissue to detect one or more metabolic aberrancies in the diseased tissue; and (d) selecting one or more therapeutic agents for the subject, wherein the agents reduce the difference that was detected in the CMP profile from the diseased tissue compared to the reference tissue.

In another aspect, the present disclosure provides a method of selecting or identifying one or more metabolic aberrancies resulting from a cellular response selected from the group consisting of: (a) obtaining a computational molecular phenotype (CMP) profile from a diseased tissue obtained from a subject; (b) obtaining a CMP profile from a reference tissue; (c) determining whether the CMP profile measured for the diseased tissue is different than the CMP profile from the reference tissue to detect one or more metabolic aberrancies in the diseased tissue relating to: anaerobic metabolism, abnormal growth, apoptosis, cytoskeletal remodeling, altered gene transcription, motility, differentiation, proliferation, inflammation or angiogenesis; and (d) selecting one or more therapeutic agents for the subject, wherein the agents reduce the difference that was detected in the CMP profile from the diseased tissue compared to the reference tissue with respect to: anaerobic metabolism, abnormal growth, apoptosis, cytoskeletal remodeling, altered gene transcription, motility, differentiation, proliferation, inflammation or angiogenesis.

In one embodiment, the one or more therapeutic agents are selected based on prior success in reducing the one or more metabolic aberrancies. In one embodiment, selecting of one or more therapeutic agents for the subject further comprises basing the selection on relevant clinical or personal information from the individual. For example, the information includes lifestyle, health, nutritional status, ethnic background, diet, age, sex and/or weight of the individual, current or past vitamin and/or drug regime or treatments, medical conditions and/or any allergies.

In another aspect, the disclosure provides a method for monitoring the effectiveness of therapeutic agents for the treatment of a disease, the method comprising: (a) obtaining a first computational molecular phenotype (CMP) profile from a diseased tissue obtained from a subject; (b) administering one or more therapeutic agents to the subject; (c) obtaining a second CMP profile from a diseased tissue obtained from the subject; and (d) determining whether the first CMP profile is different than the second CMP profile to detect the effectiveness of the one or more therapeutic agents in treating one or more metabolic aberrancies associated with the disease.

The foregoing summary is illustrative only and is not intended to be in any way limiting. In addition to the illustrative aspects, embodiments, and features described above, further aspects, embodiments, and features will become apparent by reference to the following detailed description.

### BRIEF DESCRIPTION OF FIGURES

FIG. 1 depicts a block diagram of a CMP system as an example embodiment.

FIG. 2 depicts a flow diagram illustrating example operations performed by the CMP system of FIG. 1 for CMP analysis in accordance with an example embodiment.

### DETAILED DESCRIPTION

In the description that follows, a number of terms are used extensively. Definitions are provided to facilitate understanding of the invention. The terms described below are more fully defined by reference to the specification as a whole. Units, prefixes, and symbols may be denoted in their accepted SI form. Amino acids may be referred to herein by either their commonly known three letter symbols or by the one-letter symbols recommended by the IUPAC-IUBMB Nomenclature Commission.

The terms “a” and “an” as used herein mean “one or more” unless the singular is expressly specified.

As used herein, the term “aberrant level” includes any level, amount, concentration, statistical moment, or other quantification of a small molecule in a tissue, a cell, cellular compartment, or organelle which differs from that of a reference sample of the same class of cell, collection of cells, tissue compartment, cell compartment or subcellular organelle.

As used herein, the term “aberrant pattern” includes any spatial patterning, statistical moment, or other spatial quantification of a small molecule in a tissue, a cell, cellular compartment, or organelle which differs from that of a reference sample of the same class of cell, collection of cells, tissue compartment, cell compartment or subcellular organelle.

As used herein, the term “antibody” refers to monoclonal and polyclonal antibodies that fall within any antibody classes from any source, e.g., IgG, IgM, IgA, IgE, IgY, IgX, IgD, IgF or derivatives thereof. The term “antibody” also includes antibody fragments including, but not limited to, Fab, F(ab′)₂, and conjugates of such fragments, and single-chain antibodies comprising an antigen recognition epitope. An antibody may be obtained from an animal, or from a hybridoma cell line producing a monoclonal antibody, or obtained from cells or libraries recombinantly expressing a gene encoding a particular antibody.

As used herein, the terms “determining,” “measuring,” “assessing,” and “assaying” are used interchangeably and include both quantitative and qualitative determinations of a characteristic, trait, or feature. Assessing may be relative or absolute. “Assessing the presence of” includes determining the amount of something present, as well as determining whether it is present or absent.

As used herein, the term “biomarker” refers to one or more small molecules or a profile of small molecules which are differentially presented in a disease sample as compared to a reference sample.

As used herein, the term “profile” (used interchangeably with “signature”) refers to a collection of small molecules present in a sample.

As used herein, the term “basis set” refers to a collection of small molecules treated as a linearly independent spanning set, visualized as an N-dimensional vector space (N-space), which is differentially populated in a disease sample as compared to a reference sample.

As used herein, the term “diagnosis” means detecting a disease or disorder or determining the stage or degree of a disease or disorder. The term “diagnosis” also encompasses determining the therapeutic effect of a drug therapy, or predicting the pattern of response to a drug therapy. The diagnostic methods may be used independently, or in combination with other diagnosing and/or staging methods known in the medical arts for a particular disease or disorder, e.g., cancer.

As used herein, the phrase “difference of the level” refers to differences in the quantity of a particular biomarker present in a sample as compared to a control. In one embodiment, a biomarker can be one or more small molecules or a profile of small molecules. The biomarker may be present at an elevated amount or at a decreased amount in samples of diseased patients compared to a reference level.

In one embodiment, a “difference of a level” may be a statistically significant difference between the detectable quantity of the biomarker present in a sample as compared to a control. For example, a difference may be statistically significant if the measured level of the particular small molecule falls outside of about 1.0 standard deviations, about 1.5 standard deviations, about 2.0 standard deviations, or about 2.5 stand deviations of the mean of any control or reference group.

In one embodiment, a “difference of a signature” may be a statistically separable basis set distribution in a sample as compared to a control. For example, a difference may be separable if the measured integrals of the N-space distributions have overlaps of less than 0.01%, less than 0.05%, less than 0.1%, less than 0.5%, less than 1%, less than 5%, less than 10%, less than 20%, less than 30%, less than 40%, less than 50%, less than 60%, less than 70%, less than 80%, or less than 90%.

As used herein, the term “effective amount” of a test compound or therapeutic agent is a quantity sufficient to achieve a desired therapeutic and/or prophylactic effect, for example, an amount which results in the prevention of or a decrease in the symptoms associated with a disease that is being treated, e.g., cancer. The amount of compound administered to the subject will depend on the type and severity of the disease and on the characteristics of the individual, such as general health, age, sex, body weight and tolerance to drugs. It will also depend on the degree, severity or stage of disease. The skilled artisan will be able to determine appropriate dosages depending on these and other factors.

As used herein, the term “reference level” refers to an amount and/or concentration of a biomarker or basis set from a reference sample, which may be of interest for comparative purposes. In one embodiment, a reference level may be the level of at least one biomarker expressed as an average of the level of the biomarker from samples taken from a control population of healthy subjects. In another embodiment, the reference level may be the level of the biomarker in the same subject at an earlier time, i.e., before the present assay. In even another embodiment, the reference level may be the level of the biomarker in the subject prior to receiving a treatment regime. In an illustrative embodiment, a reference level is a comparative profile from normal or healthy tissue.

As used herein, the term “reference pattern” refers to a spatial or temporal concentration of a biomarker or basis set from a reference sample, which may be of interest for comparative purposes. In one embodiment, a reference pattern may be the spatial distribution of a biomarker or basis vector visualized in samples taken from a control population of healthy subjects. In another embodiment, the reference level may be the spatial distribution of a biomarker or basis vector in the same subject at an earlier time, i.e., before the present assay. In even another embodiment, the reference level may be the spatial distribution of a biomarker or basis vector in the subject prior to receiving a treatment regime. In an illustrative embodiment, a reference pattern is a comparative profile from normal or healthy tissue.

As used herein, the term “sample” may include, but is not limited to, bodily tissue or a bodily fluid such as blood (or a fraction of blood such as plasma or serum), lymph, mucus, tears, saliva, sputum, urine, semen, stool, CSF, ascities fluid, or whole blood, and including biopsy samples of body tissue. It also may include samples from any organism. In one embodiment, the sample is a biopsy tissue from a patient having or suspected of having a disease.

As used herein, the term “screening” means determining whether a test compound has capabilities or characteristics of preventing or slowing down (lessening) the targeted pathologic condition stated herein, including, but not limited to cancer or any complications thereof.

The term “small molecules” refers to organic and inorganic molecules which are present in the cell, cellular compartment, or organelle. The term does not include polymers above 800 Daltons molecular weight. The small molecules of the cell are found free in solution in the cytoplasm, sequestered in membranes or attached to binding proteins, or in other organelles, such as the mitochondria or peroxisomes, where they form pools of intermediates which can be metabolized further. The term “small molecule” includes signaling molecules and intermediates in the chemical reactions that transform energy derived from food into usable forms. Examples of small molecules include carbohydrates (sugars), alkyl and cyclic alcohols, polyenes, alkaloids, glycosides, flavonoids, carboxylates, lipids (e.g. fatty acids), amines, amino acids, cofactors and vitamins, steroids and terpenes, nucleobases and their derivatives (nucleosides and nucleotides), pyrroles, phenazines, antibiotics (e.g. polyketides, polypeptides and aminoglycosides), small oligomers (glutathione, sucrose, and neurohormonal peptides) and various intermediates of metabolic and signaling pathways.

As used herein, the term “subject” generally refers to a mammal, such as a human, but can also be any organism such as a plant, fungus, bacterium, or an animal such as a domestic animal (e.g., a dog, cat, or the like), a farm animal (e.g., a cow, a sheep, a pig, a horse, or the like) or a laboratory animal (e.g., a monkey, a rat, a mouse, a rabbit, a guinea pig, or the like). The term “patient” refers to a “subject” who is, or is suspected to be, afflicted with a disease, e.g., cancer. The patient may be human, animal (in veterinary care), plant (in agronomy), or fungal (in mycology)

As used herein, the term “treating” or “treatment” refers to both therapeutic treatment and prophylactic or preventative measures, wherein the object is to prevent, slow down, or lessen the targeted pathologic condition or disorder. A patient is successfully “treated” for a disorder if, after receiving a therapeutic amount of a test compound according to the methods of the present technology, the subject shows observable and/or measurable reduction in, or absence of, one or more signs or symptoms of a disease or condition.

### Overview

Disclosed herein are methods for detecting the presence or absence of disease in subjects based, at least in part, on results of Computational Molecular Phenotyping (CMP) analysis on a sample. Further disclosed herein are methods for monitoring the status of subjects diagnosed with disease based at least partially on results of CMP analysis on a sample. The test samples disclosed herein are represented by, but not limited in anyway to, biopsy samples of body tissue. This disclosure is drawn, inter alia, to methods of diagnosing, monitoring, and treating disease.

The metabolic features of distinct cell classes are difficult to capture in heterocellular tissue contexts. These features include signal diversity and cell patterning across cell classes, as well as precision and variability within classes. A key part of signature diversity arises from the compartmentalization of cells into metabolically and functionally distinct populations. Imaging those populations and measuring their metabolic features has been hampered by the absence or poverty of spatial resolving power in conventional tools for measuring small molecules such as chromatography (thin-layer, gas, high-pressure, liquid), mass spectrometry, spectroscopy (including infrared and Fourier-transform infrared imaging spectroscopy), or numerous bioassays based on biofluids, tissue homogenates, tissue pieces, cell agglomerates, or cell extracts. However, CMP allows visualization of metabolites, such as amino acids, in individual cells (including those in complex tissues) with up to 200 nm resolution in optical modes and up to 20 nm resolution in electron optical modes. CMP shows that all cells exist within statistically defined metabolic envelopes, which can be visualized in any tissue (e.g. muscle, neural, hepatic, renal, endocrine, exocrine, vascular, connective, and immunological tissues), allowing visualization of previously occult heterocellular physiological relationships. This approach also has the advantage of identifying rare populations of cells whose signals are averaged out with biofluid approaches. CMP reports activities of metabolic pathways. All vertebrate tissues are heterocellular arrays, each cell class manifesting a different metabolic profile.

A metabolon is an array of cells serving connected metabolic functions in a tissue compartment. A metabolome is a quantitative small molecule profile that cells in a metabolon use to negotiate physiologic operations such as osmoregulation, pH regulation, reactive oxygen species buffering, polymer assembly, signaling, energy conversion and storage, group transfer and proliferation. Though routine histology can report generic cell morphologies and patternings, it cannot disclose metabolic relationships nor discover metabolic variation in subsets of cells. CMP can unravel complex metabolic dependencies, whether normal or aberrant. CMP provides a metabolomics tool with cellular resolution, and far surpasses imaging mass spectrometry in resolution, speed, precision, and cost. A full description of tissue metabolons and metabolomes requires knowledge of cell classes, numbers, patterns, coupling rules and metabolite compartmentalization, parameters often unknown for most tissues. Proteomics, genomics and tissue-based metabolomics models currently offer little insight regarding the selective advantages of building complex tissues from diverse cell classes. In contrast, CMP imaging of core metabolites in cells of complex tissues unmasks remarkably high metabolic diversity across and corresponding metabolic precision within constituent cell classes. In disease states such as cancer, metabolic pathways may be deranged and may become aberrantly interconnected leading to abnormal cellular signatures. The present methods can be used to identify aberrant metabolic signatures associated with a diseased state in a cell or collection of cells. Once the aberrant metabolic signatures have been identified, therapeutic approaches may be selected for the patient. Restoration of normal metabolic patterns may be monitored on the molecular level, or may be monitored by observing cellular responses.

In one aspect, the methods generally provide for the measuring and comparison of a small molecule signature from a diseased sample. Accordingly, the various aspects relate to the collection, preparation, separation, identification, characterization, and comparison of the abundance of small molecule signatures in a test sample. The small molecule signature is useful, alone or in combination with other clinical factors, to determine the presence or absence of disease or any progressive state thereof. A small molecule signature is indicative of the metabolic or environmental state of the cells that are examined, which, in turn, relates to the disease state of the organism. By measuring these metabolic signatures, one can diagnose a patient, and/or select an appropriate treatment regime. Accordingly, another aspect includes selecting a treatment regime based on the absence, presence, or extent of the metabolic aberrancy in the subject.

In accordance with another aspect, CMP is applied to the field of predictive medicine in which diagnostic assays, prognostic assays, pharmacometabolomics, and monitoring clinical trials are used for prognostic (predictive) purposes to thereby treat an individual. Accordingly, one aspect of the present technology relates to assays for determining, by CMP, small molecule signatures in the context of a biological sample (e.g., cells, tissue, cellular organelles) to determine whether an individual is at risk of developing a disorder, associated with aberrant small molecule patterns. The technology also provides for prognostic (or predictive) assays for determining whether an individual is at risk of developing a disorder associated with the relevant small molecules. For example, aberrant patterns of small molecules can be profiled from a biological sample using CMP. Such assays can be used for prognostic or predictive purpose to thereby prophylactically treat an individual prior to the onset of a disorder characterized by or associated with a relevant small molecule. The technology also pertains to selecting and monitoring the influence of agents (e.g., drugs, compounds) on the metabolic status of the cell or collection of cells as described in further detail in the following sections. These aspects of the disclosure will be described in further detail in the following sections.

### Computational Molecular Phenotyping (CMP)

In some embodiments, the present methods use computational molecular phenotyping (CMP) to profile the metabolism of normal and diseased cells. This method quantitatively profiles metabolites in a tissue (e.g., all the natural amino acids, glucosamine, glutathione, taurine, and many other small molecules) with cellular resolution by ultrathin tissue section arrays using hapten-specific antibodies. CMP allows for the interrogation of metabolic profiles of individual cells along with changes in morphology. CMP allows the assessment of characteristic metabolite pools of individual cells in any tissue. Subsequently, image processing, pattern recognition and statistical analysis can extract previously inaccessible molecular signatures that differentiate otherwise morphologically indistinguishable cells.

In a suitable embodiment, CMP combines four technologies: (1) molecular trapping, (2) high density ultrathin tissue section arrays, (3) quantitative immunoprobes targeting small molecules, and (4) pattern recognition. By probing each cell for 2-20 distinct molecules (with up to 100 molecules possible via multiplexing), CMP forms images of metabolite mixtures, translates them into quantified multivariate signatures, and uses pattern recognition to group cells into statistical classes sharing a signature. Theme maps of these classes provide a means to index metabolic diversity while maintaining the structure of heterocellular tissues, revealing cell size, position, density, patterning and signature.

Preparation of Tissue Section Arrays and Molecular Trapping.

An illustrative embodiment of the preparation of tissue section arrays is described below. A sample, such as a sample suspected of containing diseased cells (or a normal sample for comparison purposes), is obtained and tissue cores are embedded into epoxy resin blocks. Sections are cut and arranged in comparative tissue section arrays on an assay device. The tissue arrays are immunostained for specific small molecule markers, each of which quantitatively binds to a marker. Then, the level or pattern of each marker is reported.

Samples may include, but are not limited to, cellular samples collected from body fluids, such as blood, urine, spinal fluids, and lymphatic systems; epithelial cell-based organ systems, such as the pulmonary tract, e.g., lung sputum, urinary tract, e.g., bladder washings, genital tract, e.g., cervical PAP smears, and gastrointestinal tract; and fine needle aspirations from solid tissue sites in organs and systems such as the breast, pancreas, liver, kidneys, thyroid, bone marrow, muscles, prostate, and lungs; biopsies from solid tissue sites in organs and systems such as the breast, pancreas, liver, kidneys, thyroid, bone marrow, muscles, prostate, and lungs; and histology specimens, such as tissue from surgical biopsies.

In one embodiment, CMP is performed with 200 nm serial sections floated onto ultrapure water droplets on array spot slides. Sectioning is done manually. As many as a dozen samples can be multiplexed into a single bloc.

In one embodiment, the small molecules in the ultrathin sections are trapped and probed using anti-hapten IgG antibodies. Trapping small molecules for visualization involves mimicking the structures formed during hapten production. For example, the bifunctional reagent glutaraldehyde (glutardialdehdye, pentanedial) is an effective tool for trapping free small amines to the immobile protein matrix primary amino groups and emergent imines. IgG binding and washing proceeds according to standard procedures known in the art.

CMP Targets and Probes.

Small molecules include elements and their molecular forms, ions, inorganic compounds, organic species formed by group transfer and oligomers formed by ligation reactions (e.g. glutathione). Visualizing signatures, tracking phenotype dynamics, and screening molecular interventions all require quantitative profiling across cell classes. These measures can be uniquely acquired via CMP with anti-hapten IgG libraries. Examples of small molecules that may be detected using CMP include the classes of compounds shown in Table 1.

TABLE 1
Exemnlary Small Molecules Detected by CMP

| Class | Exemplary Small Molecules |
|---|---|
| Aliphatics | L-alanine, L-aspartate, L-arginine, L-asparagine, β-alanine, L- |
| | citrulline, L-cysteine, L-cystine, L-glutamate, L-glutamine, glycine, |
| | L-isoleucine, L-leucine, L-lysine, L-methionine, L-ornithine, L- |
| | serine, D-serine, L-threonine, L-valine, 4-aminobutyrate, 3-phospho- |
| | serine, phospho-ethanolamine, Ethanolamine, Putrescine, Ac |
| | Putrescine, Spermine, N—Ac Spermine, Spermidine, N—Ac |
| | Spermidine, cadaverine, carnitine, dimethylglycine, betaine, N—Ac |
| | glutamate, N—Ac asp-glutamate, N—Ac lysine, N-carbamoyl asp, 5- |
| | aminovalerate, oxo-5-aminovalerate, L-arginine-phosphate, L- |
| | arginosuccinate, carbamate, carbamoyl phosphate, carbamoyl |
| | sarcosine, sarcosine, trimethyllysine, 2-aminoadipate, selenocysteine |
| Aromatics | tryptophane, tyrosine, phenylalanine, proline, hydroxyproline, |
| | histamine, kynurenine, melatonin, tyramine, monoiodotyrosine, |
| | diiodotyrosine T2, triiodotyrosine T3, tetraiodotyrosineT4 |
| ROS Molecules | glutathione (red), glutathione (ox), cysteinylglycine, gamma- |
| | glutamylcysteine |
| Nucleics | Adenine, Adenosine, dAdenosine, AMP, dAMP, dADP, dATP, S-AM, |
| | Cytidine, Cytosine, dCytosine, CMP, CDP, CTP, dCMP, dCDP, dCTP, |
| | Guanine, Guanosine, GMP, GDP, GTP, dGMP, dGDP, dGTP, GDP- |
| | mannose, GDP-fucose, Uracil, Uridine, UMP, UDP, UTP, dUMP, |
| | dUDP, dUTP, UDP-glucose, Thymine, dThymidine, dTMP, dTDP, |
| | dTTP, NAD/NADH, NADP/NADPH, aminoacylAMP, allantoin, |
| | allantoate, Urate |
| Carboxylates | Pyruvic acid, 3-phosphoglycerate, 2-phosphoglycerate, glycerate, |
| | succinate, oxaloacetate, malate, fumarate, 2-oxoglutarate |
| Metabolite analogues | D-alanine, D-aspartate, D-arginine, D-asparagine, D-citrulline, D- |
| and probes | cysteine, D-cystine, D-glutamate, D-glutamine, glycine, D- |
| | isoleucine, D-leucine, D-lysine, D-methionine, D-ornithine, D-serine, |
| | D-threonine, D-valine, D-alanine, D-asparagine, D-cysteine, D- |
| | serine, canavanine, 1-amino-4-guanidobutane, 1-amino-2-oxo- |
| | guanidopropane, guanidinium, aminoguanidinium, guanidosuccinate, |
| | aminoisobutyrate, isoguvacine, |
| Sugars | D-glucose, D-glucuronate, D-6-phospholuconate, myo-inositol, |
| | inositol-1-PP,, inositol-1,4-PP,, inositol-1,4,5-PP, glucosamine |
| Cofactors | CoASH, Acetyl CoA, Succinyl CoA, Folate, Tetrahydrofolate, |
| | Formyl THF, Methylenyl THF, THF polyglu, THB, DHB, Thiamine, |
| | Thiamine-PP, FAD, FMN, Pyridoxamine, Cobalamin, Pantothenate, |
| | Biotin, Quinolinate, Ascorbate |
| Steroids/Precursors | Mevalonate, Mevalonate 5P,PP, Testosterone, Estradiol, Estrogen, |
| | Progesterone, Cortisol, Dihdroxycalciferol |
| Bilins, Bile Acids | Porphobilinogen, Uroporphyrins, Heme, Cytochromes, Urobilins, |
| | Stercobilins, Bilirubin, Bilirubin glucuronides, Glycocholate, |
| | Cholate, Taurocholate |
| Eicosanoids | Arachidonate, Prostaglandins, Leukotrienes, Leukotriene C4 |
| Polyketides/peptides | Penicillins, Cephalosporin, Streptomycin, Oxytetracycline, creatine, |
| | creatine-P |

CMP uses multiple anti-hapten IgG probes to bind to small molecules. The antibodies can be readily prepared using procedures generally known in the art. See, e.g., Harlow and Lane, Antibodies: A Laboratory Manual, Cold Spring Harbor Press, 1988. Modifications are required for using small molecule haptens. See, Landsteiner K (1945) The specificity of serological reactions. Boston: Harvard University Press. 450 p. Typically, the small molecule against which an immunoreactive antibody is desired is used as the hapten target for producing an immune response in a host animal. The antibodies can be polyclonal. To produce the polyclonal antibody, various animal hosts can be employed, including, e.g., mice, rats, rabbits, goats, guinea pigs, hamsters, avians, etc. Small molecule targets antigens (haptens) are be conjugated to a carrier protein such as keyhole limpet hemocyanin (KLH), bovine serum albumin (BSA), ovalbumin, or Tetanus toxoid by a coupling agent such as carbodiimide or glutaraldehyde. The results of these immunizations, while polyclonal, are monoepitopic, since only a single target “residue” is used. Any conventional adjuvants may be used to boost the immune response of the host animal to the protein complex antigen. Suitable adjuvants known in the art include, but are not limited to, Complete Freund's Adjuvant, incomplete Freund's Adjuvant, aluminum salts, MF59 from Chiron (Emeryville, Calif.), monophospholipid, synthetic trehalose dicorynomycolate (TDM) and cell wall skeleton (CWS) both from Corixa Corp. (Seattle, Wash.), non-ionic surfactant vesicles (NISV) from Proteus International PLC (Cheshire, U.K.), and saponins The antigen preparation can be administered to a host animal by subcutaneous, intramuscular, intravenous, intradermal, or intraperitoneal injection, or by injection into a lymphoid organ.

The antibodies may also be monoclonal. Such monoclonal antibodies may be developed using any conventional techniques known in the art. For example, the hybridoma method is now a well-developed technique that can be used. Essentially, B-lymphocytes producing a polyclonal antibody against a protein complex can be fused with myeloma cells to generate a library of hybridoma clones. The hybridoma population is then screened for antigen binding specificity and also for immunoglobulin class (isotype). In this manner, pure hybridoma clones producing specific homogenous antibodies can be selected. See generally, Harlow and Lane, Antibodies: A Laboratory Manual, Cold Spring Harbor Press, 1988. Alternatively, other techniques known in the art may also be used to prepare monoclonal antibodies, which include but are not limited to the EBV hybridoma technique, the human N-cell hybridoma technique, and the trioma technique.

In addition, antibodies selectively immunoreactive with small molecules may also be recombinantly produced. For example, cDNAs prepared by PCR amplification from activated B-lymphocytes or hybridomas may be cloned into an expression vector to form a cDNA library, which is then introduced into a host cell for recombinant expression. The cDNA encoding a specific desired protein may then be isolated from the library. The isolated cDNA can be introduced into a suitable host cell for the expression of the protein. Thus, recombinant techniques can be used to produce specific native antibodies, hybrid antibodies capable of simultaneous reaction with more than one antigen, chimeric antibodies (e.g., the constant and variable regions are derived from different sources), univalent antibodies that comprise one heavy and light chain pair coupled with the Fc region of a third (heavy) chain, Fab proteins, and the like. Antibody fragments such as Fv fragments, single-chain Fv fragments (scFv), Fab′ fragments, and F(ab′)₂ fragments can also be recombinantly produced.

Image Visualization and Analysis.

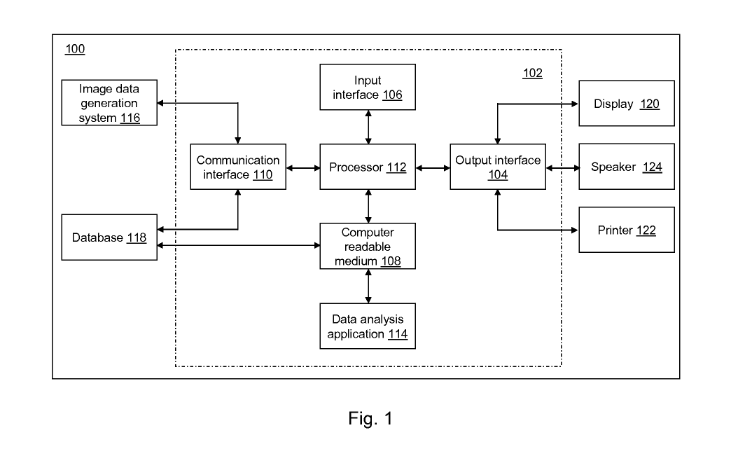

In one embodiment, the small molecule signals in immunoreacted sections are imaged and analyzed as follows. With reference to FIG. 1, a block diagram of a CMP system 100 is shown in accordance with an example embodiment. CMP system 100 may include an image data generation system 116, a database 118, a computing device 102, a display 120, a printer 122, and a speaker 124. Different and additional components may be incorporated into CMP system 100. Computing device 102 may include an output interface 104, an input interface 106, a computer-readable medium 108, a communication interface 110, a processor 112, and a CMP application 114. Computing device 102 may be a computer of any form factor. Different and additional components may be incorporated into computing device 102. Display 120, printer 122, and speaker 124 are example output devices for use with computing device 102.

In the embodiment illustrated in FIG. 1, image data generation system 116 generates image data of tissue sections. The source of and the dimensionality of the image data is not intended to be limiting. In an example embodiment, the source of the image data is an 8-bit scientific monochrome camera. Image data generation system 116 may provide the image data to computing device 102 directly through communication interface 110 or may provide the image data to computing device 102 in the form of a memory media such as a compact disk (CD), digital versatile disk (DVD), etc.

As another option, image data generation system 116 may store the image data in database 118. Database 118 may include any type of storage architecture. Storage architectures include files in a file system, native XML databases, relational databases, SQL databases, etc. Database 118 may comprise a file system including a plurality of data files. Database 118 may be accessed from computing device 102 using communication interface 110 or may be stored in computer readable medium 108.

Output interface 102 provides an interface for outputting information for review by a user of CMP system 100. For example, output interface 102 may include an interface to display 120, printer 122, speaker 124, etc. Display 120 may be a thin film transistor display, a light emitting diode display, a liquid crystal display, or any of a variety of different displays known to those skilled in the art. Printer 122 may be any of a variety of printers as known to those skilled in the art. Speaker 124 may be any of a variety of speakers as known to those skilled in the art. Computing device 102 may have one or more output interfaces that use the same or a different interface technology. Display 120 and/or printer 122 further may be accessible to computing device 102 through communication interface 110.

Input interface 106 provides an interface for receiving information from the user for entry into computing device 102 as known to those skilled in the art. Input interface 106 may use various input technologies including, but not limited to, a keyboard, a pen and touch screen, a mouse, a track ball, a touch screen, a keypad, one or more buttons, etc. to allow the user to enter information into computing device 102 or to make selections presented in a user interface displayed on display 104. Input interface 106 may provide both an input and an output interface. For example, a touch screen both allows user input and presents output to the user. Computing device 102 may have one or more input interfaces that use the same or a different input interface technology.

Computer-readable medium 108 is an electronic holding place or storage for information so that the information can be accessed by processor 112 as known to those skilled in the art. Computer-readable medium 108 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., CD, DVD, . . . ), smart cards, flash memory devices, etc. Computing device 102 may have one or more computer-readable media that use the same or a different memory media technology. Computing device 102 also may have one or more drives that support the loading of a memory media such as a CD or DVD. Computer-readable medium 108 may comprise a cache in which data can be stored temporarily for rapid access by processor 112. Computer-readable medium 108 further may comprise database 118.

Communication interface 110 provides an interface for receiving and transmitting data between devices using various protocols, transmission technologies, and media as known to those skilled in the art. The communication interface may support communication using various transmission media that may be wired or wireless. Computing device 102 may have one or more communication interfaces that use the same or a different communication interface technology. Data may be transferred between computing device 102 and image data generation system 116 using communication interface 110. Additionally, communication interface 110 may provide connectivity to other systems. For example, communication interface 110 may provide connectivity to database 118.

Processor 112 executes instructions as known to those skilled in the art. The instructions may be carried out by a special purpose computer, logic circuits, or hardware circuits. Thus, processor 112 may be implemented in hardware, firmware, or any combination of these methods. The term “execution” is the process of running an application or the carrying out of the operation called for by an instruction. The instructions may be written using one or more programming language, scripting language, assembly language, etc. Processor 112 executes an instruction, meaning that it performs the operations called for by that instruction. Processor 112 operably couples with output interface 104, with input interface 106, with computer-readable medium 108, and with communication interface 110 to receive, to send, and to process information. Processor 112 may retrieve a set of instructions from a permanent memory device and copy the instructions in an executable form to a temporary memory device that is generally some form of RAM. Computing device 102 may include a plurality of processors that use the same or a different processing technology.

CMP application 114 performs operations associated with processing image data of tissue section. Some or all of the operations described may be embodied in CMP application 114. The operations may be implemented using hardware, firmware, software, or any combination of these methods. With reference to the example embodiment of FIG. 1, CMP application 114 is implemented in software stored in computer-readable medium 108 and accessible by processor 112 for execution of the instructions that embody the operations of image CMP application 114. CMP application 114 may be written using one or more programming languages, assembly languages, scripting languages, etc. CMP application 114 may be implemented as a plug-in to a data processing and visualization application.

Components of CMP system 100 may be housed in a single device, positioned in a single location, a single facility, and/or may be remote from one another. Thus, image data generation system 116, database 118, and/or computing device 102 may be integrated into a single system. Image data generation system 116, database 118, and/or computing device 102 may be connected directly through a wired or wireless technology. For example, image data generation system 116 may connect to computing device 102 using a cable for transmitting information between image data generation system 116 and computing device 102. Image data generation system 116 may connect to computing device 102 using a network. Image data may be stored electronically and accessed using computing device 102. Image data generation system 116 and computing device 102 does not need to be connected. Instead, the data acquired using image data generation system 116 may be manually provided to computing device 102. For example, the data may be stored on electronic media such as a CD, a DVD, a flash drive, etc. After receiving the data, computing device 102 may initiate processing of the data automatically or under control of an operator of computing device 102.

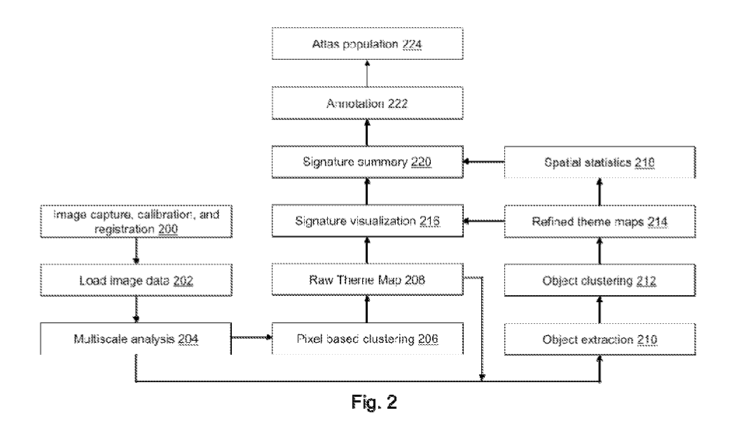

With reference to FIG. 2, example operations associated with CMP application 114 of FIG. 1 are described. Additional, fewer, or different operations may be performed, depending on the embodiment. The order of presentation of the operations of FIG. 2 is not intended to be limiting. In an operation 200, after preparation of the tissue sections, image data of the tissue sections is captured, calibrated, and registered. IgG binding in the postembedding procedure is almost entirely a surface phenomenon, independent of section thickness, and identical immunoreactivities for an entire antigen panel may be obtained over the range of 40-1000 nm section thickness. For example, images of the tissue sections following binding can be captured under optimal conditions of signal-to-noise, with stabilized power supplies using scientific monochrome cameras. In one embodiment, images are captured at a resolution of 183 nm/pixel (slightly oversampled) with a 1.0 NA 40× planapochromatic oil immersion objective and high-resolution scanning stage. Captured images are mosaicked and registered into large multichannel datasets for classification, where each channel contains the quantitative distribution of one small molecule. The power of the single-section postembedding technique derives from strong signal segregation (only one probe is typically applied per section). Serial sections are registered to exploit this power and thinner sections yield better registrations. In another embodiment, strong oxidizers and reducers are used to erase the immune signal and the sample can be reprobed with another antibody. This further improves resolution. In another embodiment, multiple antibodies are applied concurrently or serially to a single section.

After image capture, the sample signals are calibrated against artificial standards containing known concentrations of a reference target molecule. As all binding follows similar kinetics, only a single reference is necessary to pin all signals in a given slide.

The basic concepts of digital image registration involve identifying common points known as control points across a set of images. Briefly, one image is selected as a master and the translations, rotations, scalings, and shears required to align all points on any image to the master image are calculated by spatial interpolation. Most registrations involve first-order polynomial or simple affine transformations: linear coordinate transformations plus translation terms. On occasion, however, local distortions such as a stretched section will preclude successful alignment with a first-order model, and a higher-order polynomial or a thin-plate spline solution may be estimated. Series of sections may be aligned pairwise by conventional image registration methods Most images may be registered with better than 250 nm RMS (root mean square).

Low-pass filtering is used to suppress intracellular variations arising from intracellular inclusions such as mitochondria, nuclei, endosomes, etc., which are routinely visible with light microscopic ultrathin section immunocytochemistry.

Small molecule signals in optical immunoreacted sections are optically absorbing density images and scale inversely with pixel value, or optically emitting intensity images and scale directly with pixel value. The conventional way to examine correlated signals involves rgb mapping, using the brightness signals from one amino acid to drive one color gun. Therefore, in one embodiment, density images are inverted with a logical NOT operation so that immunoreactivity scales with pixel value (brightness). Thus, any triplet of amino acids can be simultaneously viewed with rgb mapping. This serves as a useful survey tool, but cannot be used for quantitative analysis. For quantitative analysis, multidimensional pattern recognition is used.

In an operation 202, image data is loaded for processing by CMP application 114. For example, the image data may be stored at computing device 102 and selected for input to CMP application 114 using an interactive dialog box that allows a user to select the data source as well as the loading mechanism associated with the data source. As another alternative, the image data may be streamed to computing device 102 from image data generation system 116 or the dataset may be received by computing device 102 from database 118. The captured, calibrated, and registered image data may be stored as lab archives in computer readable medium 108 and/or database 118.

In an operation 204, multi-scale analysis of the loaded image data is performed which includes pixel based clustering performed in an operation 206 and object extraction performed in an operation 210. After pixel based clustering a raw theme map is created in an operation 208. The raw theme map is input to the object extraction operation 210. In an operation 212, object clustering is performed. For example, in some embodiments, pattern recognition in N-space is used to classify small molecules in serial tissue sections by treating the measurements as a basis set where N is the number of different molecules probed. Algorithms such as K-means and isodata clustering extract N-dimensional means and variances for classes by calculating hypersurface decision boundaries. Starting from some initial means, the K-means algorithm calculates an initial decision boundary, assigns all points on one side to a group, and iteratively calculates new means and boundaries until it converges on clusterings that do not change significantly with subsequent iterations. All points on one side of the decision boundary constitute a theme class. Ultimately, such algorithms converge on K theme classes that are more or less separated in N-space. Theme classes represent clusters of highly correlated signals in the N-space for which decision boundaries can be defined, and each set of N means and variances characterizing a single theme class is the formal class signature. In very large or complex datasets, class dimensional reduction via Principal Components Analysis non-destructively assists the initialization of K-means or isodata clustering.

Results of K-means classifications may be visualized in multiple ways. In an operation 214, theme maps are constructed by coding every pixel in the original image according to theme class, allowing one to see how well classifications of structural space based on biochemical signals alone correspond to real cells. In an operation 218, spatial statistics are calculated. For example, bivariate probability density distributions allow examination of both separations and distributions of theme classes for pairs of biomarkers. Raw bivariate scatterplots of N-dimensional data mapped onto a two space are augmented by viewing the single-class ellipses for each theme class: the 2 SD borders of the bivariate Gaussians underlying each theme class. Univariate probability density distributions for each theme class are extracted from original N-space data frames by using each theme class as a binary mask). This reveals the extent to which the strengths of various small molecule signals overlap across cell classes, but cannot properly encode covariance. In an operation 216, a signature matrix is constructed as a small multiple plot of all the aligned univariate probability density distributions for each small molecule versus all theme classes. In an operation 220, a signature summary is created. The analysis results may be stored as data archives including registered channels, theme maps, data matrices, etc. in computer readable medium 108 and/or database 118. In an operation 222, the visualization results can be presented on display 120 under control of processor 112 executing data analysis application 114. A user interacting with CMP system 100 can annotate the visualization results. Indications associated with the annotations are received by processor 112 and may be stored in computer readable medium 108 or database 118 with the visualization results or separate from the visualization results.

Derived classes can be tested for their statistical separabilities by a probability of error (pₑ) assessment. This is typically done by calculating the N-dimensional divergences (the combined weighted traces of the covariance and mean matrices) of the data and modeling pₑ for various a priori probability density functions. For example, transformed divergence (D^{T}) may be employed as a routine statistic for estimating the degree of pairwise theme class segregation (Swain and Davis, 1978). Other divergences such as Jeffries-Matusita or Bhattachyara divergences may be used as well. Use of D^{T} is computationally efficient, but conditioned by the assumption that the underlying univariate theme class signal distributions are largely normal or may be decomposed into single normal distributions. However, D^{T} is a robust statistic immune to even large deviations from normality. Moreover, it is an additive statistic and increasing the number of data channels (small molecules) does not decrease separability even if the new channel does not contribute further discrimination of a pair of theme classes. The relationship between D^{T} and direct calculation of probability of error (pₑ) in classification is complicated by high dimensionality of the data and differing a priori probabilities (i.e., the relative incidence of the theme class or cell types in the data set).

For practical purposes, the conventional assumption of roughly equal a priori probabilities across all theme classes is fairly reasonable, and D^{T} ranges from 0 (no separability and pₑ=1) to 2 (full separability, pₑ=0). The standard cutoff of significance in D^{T} is 1.9, corresponding to pₑ<0.01.

### Methods for the Identification of Disease Biomarkers Using CMP

In one aspect, the disclosure provides a method of identifying biomarkers, i.e. small molecules or small molecule signatures associated with a disease. The method includes comparing CMP signatures or profiles of diseased tissues, cells, cellular compartments, or organelles to a reference profile of a healthy tissue, cell, cellular compartment, or organelle. The method also involves identifying the small molecules which are present in aberrant amounts or locations in the CMP profile. The CMP profiles may be generated using pattern recognition as described above.

Small molecule biomarkers from tissue specimens intrinsically have important biological information because the diseased cells can be examined individually and as a whole in their correct geometric contexts within a heterocellular tissue to understand the biology of the diseased tissue, such as a tumor or tumor bed. Small molecule biomarkers of treatment response can indicate the probable success or failure of a treatment regimen and give clinicians adequate time to adjust therapy. Thus, CMP provides a robust method of phenotyping a diseased tissue at the cellular level. CMP allows one to assess characteristic metabolite pools of individual cells in any tissue. Subsequently, image processing, pattern recognition and statistical analysis (separability analysis) can extract previously inaccessible molecular signatures that differentiate cell classes and changed cell states. Biomarkers that may be associated with a disease include both small molecules present in an aberrant amounts or patterns in diseased cells or tissues and, in addition, small molecules which are potentially involved in disease initiation, progression or prediction. The biomarkers may be ideal drug targets, as discussed elsewhere in the application.

The term “disease” or “disease state” includes all diseases which result or could potentially cause a change of the small molecule profile of a cell, cellular compartment, or organelle in an organism afflicted with the disease including cell or tissue metabolic stress. Examples of diseases include celiac disease, lung disease, thyroid conditions, liver disease from infection, alcoholism, fatty liver disease, dermis and epidermis infections/inflammations, infectious disease, metabolic diseases (e.g., amyloidosis), cardiovascular diseases (e.g., atherosclerosis, ischemia/reperfusion, hypertension, restenosis, arterial inflammation, etc.), immunological disorders (e.g., chronic inflammatory diseases and disorders, such as Crohn's disease, reactive arthritis, including Lyme disease, insulin-dependent diabetes, organ-specific autoimmunity, including multiple sclerosis, Hashimoto's thyroiditis and Grave's disease, contact dermatitis, psoriasis, graft rejection, graft versus host disease, sarcoidosis, atopic conditions, such as asthma and allergy, including allergic rhinitis, gastrointestinal allergies, including food allergies, eosinophilia, conjunctivitis, glomerular nephritis, certain pathogen susceptibilities such as helminthic (e.g., leishmaniasis) and certain viral infections, including HIV, and bacterial infections, including tuberculosis and lepromatous leprosy, etc.), nervous system disorders (e.g., neuropathies, Alzheimer disease, Parkinson's disease, Huntington's disease, amyotrophic lateral sclerosis, motor neuron disease, traumatic nerve injury, multiple sclerosis, acute disseminated encephalomyelitis, acute necrotizing hemorrhagic leukoencephalitis, dysmyelination disease, mitochondrial disease, migrainous disorder, bacterial infection, fungal infection, stroke, aging, dementia, peripheral nervous system diseases and mental disorders such as depression and schizophrenia, etc.), oncological disorders (e.g., leukemia, brain cancer, pancreatic cancer, prostate cancer, liver cancer, stomach cancer, colon cancer, throat cancer, breast cancer, ovarian cancer, skin cancer, melanoma, etc.).

The term “reference profile” includes CMP profiles derived from healthy cells or tissues, advantageously from a similar origin as the test sample, and curated in a reference atlas. In one embodiment, the reference profile is a statistical moment of many samples of a certain cell class and/or a certain cellular compartment. In another embodiment, the reference profile is a statistical moment of the spatial patternings of many samples of a certain cell class and/or a certain cellular compartment. In another embodiment, the reference profile may be derived from a patient prior to the onset of the disease state or from cells not affected by the disease state. Or, in another embodiment the reference profile can be statistical moments of the profiles obtained from numerous sources, e.g., the reference profile may be an average or the variance of CMP profiles obtained from 3 or more subjects. The reference profile can be a CMP profile of a certain tissue or from a certain subset of cells.

Advantageously, the small molecules with aberrant distributions in the sample are identified using CMP. In one embodiment, the small molecule profile of the tissue, cell, or cellular compartment, is compared to the reference profile using pattern recognition, histogram matching or any other quantitative representation. The compounds which are present in aberrant distributions can then be used in drug design to identify deregulated cellular components. Profiles can also be made of the effects of certain agents (e.g., drugs, therapeutic agents, toxins, etc.) on both healthy and diseased tissues (e.g., tissues diseased with the type of disease treated by the therapeutic agent). The CMP profiles may further include the quantity and/or type of small molecules present.

Comparison of the reference profiles to profiles from diseased tissues can be used to identify small molecular aberrations signifying disease state. Identifying these pathways is a potential drug discovery mechanism by targeting the small molecules present in aberrant levels in sample tissues to be used and identified as targets for pharmaceutical or nutraceutical agents or as intervention targets of metabolic pathways appropriate for pharmaceutical intervention. For example, if a patient is suffering from a disease state associated with a deficiency of a certain metabolite, the molecule or a precursor thereof may be tracked in an assay that resolves the cellular sources and sinks associated with it. In another embodiment, the small molecules present in aberrant amounts or distributions may be used as targets for drug design to develop agents with enhanced activity, e.g., enhanced activity to treat the disease state associated with the aberrant amounts or distributions of the small molecule. Additionally, libraries of small molecules based on the structures of the small molecules present in aberrant amounts or distributions can be used to develop more potent therapeutics. The cellular targets and pathways could also be used to guide drug design.

In a further embodiment, the technology features diagnostic assays for the detection of disease states. For example, the method includes identifying a small molecule which is present in aberrant amounts or distributions in a particular disease state, e.g., by comparing standard profiles of diseased cells or cellular compartments with healthy cells or cellular compartments to identify compounds which are present in aberrant amounts in the diseased cell or cellular compartment. The invention also pertains to kits which include the reagent and instructions for its use to diagnose the disease.

### Diagnostic Assays

In one embodiment, the present disclosure pertains to a method for facilitating the diagnosis of a disease state of a subject. The method includes obtaining a CMP profile from a subject suspected of having and/or having a disease state, and comparing the small molecule profile from the subject to a reference CMP profile.

The disclosure provides methods of assessing CMP profiles, especially aberrant CMP profiles. Aberrant CMP profiles (e.g., excessive amounts of a particular molecule, deficient amounts of a particular molecule, the presence of a small molecule not usually present, abnormal cellular patterning, etc.) may indicate the presence of a disease state. More generally, aberrant CMP profiles may indicate the occurrence of a deleterious or disease-associated cellular metabolism contributed by small molecules present in aberrant amounts.

The reference CMP profile can be obtained from healthy subjects or subjects afflicted with the disease state which is the subject is suspected of having. The CMP profiles can be taken from a particular organ, tissue, or combinations or organs or tissues. The CMP profiles can also be taken of cells, cellular compartments, particular organelles, or extracellular material.

Statistical methods can be used to set thresholds for determining when the CMP profile in a subject can be considered to be different than or similar to a reference profile. In addition, statistics can be used to determine the validity of the difference or similarity observed between a patient's metabolite pattern and a reference pattern. Useful statistical analysis methods are described in L. D. Fisher & G. vanBelle, Biostatistics: A Methodology for the Health Sciences (Wiley-Interscience, NY, 1993) and R. O. Duda, P. E. Hart and David G. Stork, Pattern Classification (Wiley-Interscience, NY, 2001).

Once an association is established between an aberration in a CMP profile and a pathological state, then the particular physiological state can be diagnosed or detected by determining whether a patient has the particular aberration. As used herein, the term “aberration” when used in the context of CMP profiles means any detectable alterations of a small molecule amounts, moments and/or spatial distributions, including increased or decreased concentration of the small molecule in a particular cell. As will be apparent to a skilled artisan, the term “aberration” is used in a relative sense. That is, an aberration is relative to a normal condition. For example, a detectable aberration may be a difference in the level of a small molecule present in a sample as compared to a control of at least about 1%, at least about 2%, at least about 3%, at least about 5%, at least about 10%, at least about 15%, at least about 20%, at least about 25%, at least about 30%, at least about 35%, at least about 40%, at least about 50%, at least about 60%, at least about 75%, at least about 80% or more. Thus, in one embodiment, the method of diagnosis is conducted by detecting, in a patient, the CMP profile using any one of the methods described above, and determining whether the patient has an aberrant concentration of one or more small molecules. Similarly, a detectable aberration may be a difference in the variance of a small molecule present across cells in a class as compared to a control of at least about 1%, at least about 2%, at least about 3%, at least about 5%, at least about 10%, at least about 15%, at least about 20%, at least about 25%, at least about 30%, at least about 35%, at least about 40%, at least about 50%, at least about 60%, at least about 75%, at least about 80% or more. Similarly, a detectable aberration may be a difference in the patterning of a small molecule present across cells in a class as compared to a control of at least about 1%, at least about 2%, at least about 3%, at least about 5%, at least about 10%, at least about 15%, at least about 20%, at least about 25%, at least about 30%, at least about 35%, at least about 40%, at least about 50%, at least about 60%, at least about 75%, at least about 80% or more.

### Prognostic Assays

The disclosure also pertains to a method for predicting whether a subject is predisposed to having a disease state. The method includes obtaining a CMP profile from the subject; and comparing the CMP profile from the subject to a reference CMP profile, thereby predicting whether a subject is predisposed to having a disease state.

Furthermore, the prognostic assays described herein can be used to determine whether a subject can be administered an agent (e.g., peptidomimetic, protein, peptide, nucleic acid, small molecule, or other drug candidate) to treat a disease or disorder associated with an aberrant CMP profile. For example, such methods can be used to determine whether a subject can be effectively treated with a specific agent or class of agents (e.g., agents of a type which affect the CMP profile in particular ways). Thus, the present technology provides methods for determining whether a subject can be effectively treated with an agent for a disorder associated with an aberrant CMP profile in which a test sample is obtained and an aberrant CMP profile is detected (e.g., wherein the presence or relative quantity of particular relevant small molecules is diagnostic for a subject that can be administered the agent to treat a disorder associated with the aberrant small molecule profile). In some embodiments, the foregoing methods provide information useful in prognostication, staging and management of particular states that are characterized by altered CMP profiles. The information more specifically assists the clinician in designing treatment regimes to eradicate such particular states from the body of an afflicted subject.

In some embodiments, the prognostic assays are used to detect one or more metabolic indices of cellular aberrancies such as improperly distributed anaerobic metabolism, abnormal cell growth (hypertrophy), abnormal tissue growth (hyperplasia), apoptosis, cytoskeletal remodeling, altered extracellular matrix regulation, altered microfluidics (changes in coupling and adhesion), altered gene transcription, motility, differentiation, transformation, proliferation, altered signaling, inflammation or angiogenesis. A therapeutic agent may then be selected to correct the one or more cellular aberrancies.

CMP can also be used to detect the presence, absence or altered distribution of relevant small molecules, thereby determining if a subject is at risk for a disorder associated with this relevant small molecule. For example, the presence, absence or redistribution of relevant small molecules may indicate whether the process of developing a disease state has been initiated or is likely to arise in the tested cells. In suitable embodiments, the methods include detecting the presence or absence of the relevant small molecule, in a sample of cells or extracellular material from the subject.

### Predictive Medicine and Pharmacometabolomics.

Another aspect of the disclosure provides methods for determining small molecule profiles of an individual to thereby select appropriate therapeutic or prophylactic agents for that individual (referred to herein as “pharmacometabolomics”). Pharmacometabolomics allows for the selection of agents (e.g., drugs) for therapeutic or prophylactic treatment of an individual based on the CMP profile of the individual. The CMP profile of the individual is examined to predict what the person's reaction to a particular therapeutic compound will be. Yet another aspect of the technology pertains to monitoring the influence of agents (e.g., drugs or other compounds) on the CMP profiles of the patients in clinical trials.

Pharmacometabolomics is similar to pharmacogenomics but it is also able to take into account environmental and other factors which may affect an individual's response to a particular therapeutic compound. Pharmacometabolomics can be used alone or in combination with pharmacogenomics to predict an individual's reaction to a particular drug based upon their CMP profile and/or their genotype.

A functional map of the state of key metabolic pathways within a subject's diseased cells (such as tumor and pre-malignant cells) is one starting point for individualized therapy because it permits a therapy to be tailored to an individual's molecular defects. Moreover, following re-biopsy or molecular imaging, the effect of the treatment can be monitored in real time. If a subject develops resistance to an initial therapy, the treatment can also be altered to address the evolving drug resistance. The CMP profile can be used to select therapeutic agents that can oppose the aberrant metabolic pattern and return the aberrant pattern to a more normal pattern.

Differences in metabolism of therapeutics can lead to severe toxicity or therapeutic failure by altering the relation between dose and blood concentration of the pharmacologically active drug. Thus, CMP analysis of the individual permits the selection of effective agents (e.g., drugs) for prophylactic or therapeutic treatments based on a consideration of the individual's metabolic profile. Such pharmacometabolomics can further be used to determine appropriate dosages and therapeutic regimens. Accordingly, the small molecule profile of an individual can be determined to thereby select appropriate agent(s) for therapeutic or prophylactic treatment of the individual. Importantly, CMP analysis permits tissue-specific rather than global biofluids metabolomics. This means that therapeutics can potentially be better targeted.

The CMP profile of an individual can be determined to select appropriate agent(s) for therapeutic or prophylactic treatment of the individual. In addition, pharmacometabolomic studies can be used to identify an individual's drug responsiveness. This knowledge, when applied to dosing or drug selection, can avoid adverse reactions or therapeutic failure and thus enhance therapeutic or prophylactic efficiency when treating a subject with an agent, such as an agent identified by one of the exemplary screening assays known in the art.

In an illustrative embodiment, the CMP profile is used to detect anaerobic metabolism in the diseased tissue and then select a therapeutic regime to treat the cell's altered metabolism. For example, the anaerobic metabolism may be the Warburg effect. The Warburg Effect describes the shift by tumor cells to metabolize glucose anaerobically to lactate, redirecting glucose-derived carbon skeletons to macromolecule biosynthesis. Glutamine then partially substitutes for glucose in the generation of oxaloacetate for the TCA cycle (glutamine anaplerosis), with glutamate generation as an obligate intermediate. Detection of the Warburg effect in tumors is suggested to be an early sign of resistance to therapies in general and an indicator of disease progression. Certain therapeutic agents are known to inhibit the Warburg effect, e.g., Imatinib, SB-204990, 2-deoxy-D-glucose (2DG), 3-bromopyruvate (3-BrPA, Bromopyruvic acid, or bromopyruvate), 5-thioglucose and dichloroacetic acid (DCA). By determining the presence or absence of the Warburg Effect using CMP, an appropriate therapeutic regime can be selected.

### Kits

The methods described herein may be performed, for example, by utilizing pre-packaged diagnostic kits comprising at least one reagent for detecting a relevant small molecule, which may be conveniently used, e.g., in clinical settings to diagnose patients exhibiting symptoms or family history of a disease or illness involving a relevant small molecule.

A kit may be used for conducting the diagnostic and screening methods described herein. Typically, the kit should contain, in a carrier or compartmentalized container, reagents useful in any of the above-described embodiments of the diagnosis method. The carrier can be a container or support, in the form of, e.g., bag, box, tube, rack, and is optionally compartmentalized. The carrier may define an enclosed confinement for safety purposes during shipment and storage. In one embodiment, the kit includes an antibody selectively immunoreactive with a small molecule. The antibodies may be labeled with a detectable marker such as radioactive isotopes, or enzymatic or fluorescence markers. Alternatively, secondary antibodies such as labeled anti-IgG and the like may be included for detection purposes. Optionally, the kit can include one or more reagents for ultrathin tissue sectioning or for sample trapping. Instructions for using the kit or reagents contained therein are also included in the kit.

Such kits can be used to determine if a subject is suffering from or is at increased risk of developing a disorder associated with the relevant small molecule (e.g., drug resistance). For example, the kit can comprise a labeled compound or agent capable of detecting the relevant small molecule in a biological sample and means for determining the amount of the relevant small molecule in the sample (e.g., an antibody against the relevant small molecule). Kits may also include instructions for observing that the tested subject is suffering from or is at risk of developing a disorder associated with the relevant small molecule if the amount of the relevant small molecule is above or below a normal level.

### EXAMPLES

The present methods and kits, thus generally described, will be understood more readily by reference to the following examples, which are provided by way of illustration and are not intended to be limiting of the present methods and kits. The following is a description of the materials and experimental procedures used in the Examples.

### Example 1

### Computational Molecular Phenotyping for Profiling Metabolic Aberrancies in Rhabdomyosarcoma

A major goal of oncology is to develop targeted molecular therapies as an alternative or as an adjunct to traditional chemotherapy. Receptor tyrosine kinase (RTK) inhibitors are a key example of targeted therapies. However, experience with RTK therapies shows that resistance and/or alternative signaling pathways can evolve in nearly a third of all tumors; limiting efficacy of therapies based on single a factor for tumor maintenance and progression. Strategies are needed to prevent or overcome resistance, as well as new biomarkers of resistance and tumor progression that allow clinicians to better determine whether a tumor is responding to therapy.

This example uses a genetically-engineered mouse model of an aggressive childhood muscle cancer, alveolar rhabdomyosarcoma. Previous studies have shown that nearly all tumors initially respond to the prototypic RTK inhibitor (RTKi) Imatinib, but approximately one-third of tumors eventually acquire resistance by up-regulating related RTKs that are not targeted by Imatinib. Biomarkers that are predictive of resistance would be of great clinical value in improving the outcome of patient whose tumors are likely to be resistant to RTKi's.

Mouse Model of Rhabdomyosarcoma.

Rhabdomyosarcoma has two major subtypes, alveolar and embryonal. The outcome for patients with the alveolar subtype is less favorable than the embryonal subtype, especially when metastatic. Conditional mouse models of invasive, metastatic alveolar rhabdomyosarcoma were generated by re-creating mutations known to occur in this muscle cancer of children. In humans, alveolar rhabdomyosarcoma is nearly always associated with a chromosome rearrangement (translocation) fusing a Pax gene (either Pax3 or Pax7) to the Fkhr gene, thereby forming a chimeric transcription factor that acts as an oncogene. In addition, CDKN2A or p53 tumor suppressor mutations accompany Pax3:Fkhr mutations in more than half of cases. This genetically-engineered mouse model recapitulates these changes by simultaneously activating Pax3:Fkhr and inactivating CDKN2A or p53. Mice develop tumors that are as aggressive as advanced-stage human alveolar rhabdomyosarcoma. The conditional mouse model also provides the opportunity to study disease progression from the earliest time point of tumor initiation via longitudinal anatomical and molecular imaging studies, so that the mechanisms of progression and metastasis can be more fully understood.

Determine the Computational Molecular Profile of Untreated Tumors.

To assess metabolic tumor profiles, CMP is performed on tumor samples in parallel with histological studies. Multivariate analysis (principal component analysis & clustering) of combined CMP stains, necropsy findings for the extent of disease, and traditional histological and immunohistological features are performed. It is predicted that metabolite profiles significantly associated with tumor cell proliferation or apoptosis at baseline (i.e., before treatment) will be identified.

CMP analysis includes agmatine, alanine, 4-aminobutyrate, arginine, aspartate, ATP, ADP, citrulline, cysteine, glutamate, glutamine, glutathione, glucosamine, glycine, guanidoacetate, ornithine, proline, phenylalanine, serine, taurine, threonine, and tyrosine. Additional targets may be probed. CMP, imaging, registration and pattern recognition is performed by staff masked to tissue provenance. Statistical analysis of signature classes is performed on specimens correlated with extent of disease, cytodifferentiation, Mitotic Index and staining for Ki-67 and cleaved Caspase 3.

From a broad clinical perspective, biomarkers for the early prediction of resistance to therapy do not yet exist for childhood alveolar rhabdomyosarcoma. Histological and immunohistochemical assessment of proliferation and cytodifferentiation biomarkers are important for risk-stratified therapy at diagnosis (e.g., childhood neuroblastoma) and for risk-adjusted therapy during treatment (e.g., osteosarcoma). However, these and other biomarkers are not applicable to childhood alveolar rhabdomyosarcoma or many other cancers. Thus, CMP strategies are used to find effective rhabdomyosarcoma biomarkers. It is predicted that determining the metabolic state of rhabdomyosarcoma tumors by the in situ metabolomics technique of CMP will determine whether a tumor is responsive to therapy or is becoming resistant, and will lead to the identification of pathways that can be targeted in combination with RTK inhibitors to improve overall treatment response rates.

It is also predicted that biomarkers associated with the Warburg Effect will be observed in the tumor samples. The Warburg Effect describes the shift by tumor cells to metabolize glucose anaerobically, redirecting glucose-derived carbon skeletons to macromolecule biosynthesis. Glutamine then partially substitutes for glucose in the generation of oxaloacetate for the TCA cycle (glutamine anaplerosis), with glutamate generation as an obligate intermediate. The Warburg Effect is relevant to this Example because tyrosine phosphoproteins and growth factors have recently been recognized to modulate the Warburg Effect, and because early studies suggest that Imatinib inhibits the Warburg Effect and over-accelerates TCA cycle flux with an associated increase in apoptosis. Detection of the Warburg effect in tumors is suggested to be an early sign of resistance to therapies in general and an indicator of disease progression. Yet in combination with chemotherapy or as a single approach, cellular deprivation of glutamine and the resultant reversal of glutamine anaplerosis have even been associated with increased apoptosis. Thus, key metabolites can be either indirect biomarkers of treatment effect or potential therapeutic targets.

### Example 2

### Identification of Small Metabolite Biomarkers of RTKi Sensitivity and Resistance Using CMP

Studies in the rhabdomyosarcoma mouse model have shown that larger tumors respond better than smaller tumors to the RTK inhibitor Imatinib, and that the drug effect is mediated by down-regulation of Pdgfr-a directly in tumor cells with consequent induction of apoptosis. In this Example, mice are treated with Imatinib to generate sets of tumor samples that are sensitive or resistant to this RTKi.

The histological characteristics and CMP profile of these tumors is examined in a manner similar to Example 1. Specifically, multivariate analysis (PCA and clustering) is performed on the combined data from CMP, extent of disease at necropsy, traditional histological methods and whether a tumor is sensitive to Imatinib.

This Example determines metabolite profiles significantly associated with tumor sensitivity (halted progression or regression) or tumor resistance (progression). It is predicted that these observations can be translated to the clinic as a diagnostic (prognostic) method of scoring response to therapy from small clinical biopsy samples, thereby determining whether to escalate therapy, and perhaps even identifying novel metabolic interventions that abrogate resistance. If successful, this approach could be a new paradigm for other cancers.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 particles refers to groups having 1, 2, or 3 particles. Similarly, a group having 1-5 particles refers to groups having 1, 2, 3, 4, or 5 particles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

All references cited herein are incorporated by reference in their entireties and for all purposes to the same extent as if each individual publication, patent, or patent application was specifically and individually incorporated by reference in its entirety for all purposes.

1. A method for identifying a therapeutic target for the treatment of a disease, the method comprising:
(a) obtaining a small molecule profile by computational molecular phenotyping (CMP) from a diseased tissue obtained from a subject;
(b) obtaining a CMP profile from a reference tissue; and
(c) determining whether the CMP profile measured for the diseased tissue is different than the CMP profile from the reference tissue to detect one or more metabolic aberrancies in the diseased tissue, wherein the one or more metabolic aberrancies are a therapeutic target for the treatment of disease.

2. The method of claim 1, wherein the diseased tissue is a biopsy from a cancer tissue.

3. The method of claim 2, wherein the cancer tissue is selected from the group consisting of: carcinoma of the bladder, breast, colon, kidney, liver, lung, esophagus, gall-bladder, ovary, pancreas, stomach, cervix, thyroid, prostate, and skin; small cell lung cancer; squamous cell carcinoma; fibrosarcoma; rhabdomyosarcoma; astrocytoma; neuroblastoma; glioma; schwannoma; melanoma; seminoma; teratocarcinoma; osteosarcoma; xenoderoma pigmentosum; keratoctanthoma; thyroid follicular cancer; Ewing's sarcoma; and Kaposi's sarcoma.

4. The method of claim 1, wherein the reference tissue is a normal tissue, a tissue before or after a treatment, or a tissue before or after a disease or a stage of disease.

5. The method of claim 4, wherein the reference tissue is a normal tissue.

6. The method of claim 1, wherein the diseased tissue and the reference tissue are obtained from the same subject.

7. The method of claim 1, wherein the reference tissue is obtained from one subject and the diseased tissue is obtained from another subject.

8. The method of claim 1, wherein the reference tissue comprises a tissue that has not been treated with a therapeutic agent.

9. The method of claim 1, wherein the one or more metabolic aberrancies results from a cellular response selected from the group consisting of: improperly distributed anaerobic metabolism, abnormal cell growth (hypertrophy), abnormal tissue growth (hyperplasia), apoptosis, cytoskeletal remodeling, altered extracellular matrix regulation, altered microfluidics (changes in coupling and adhesion), altered gene transcription, motility, differentiation, transformation, proliferation, altered signaling, inflammation or angiogenesis.

10. The method of claim 1, wherein the one or more metabolic aberrancies is the Warburg effect.

11. The method of claim 1, wherein obtaining a CMP profile comprises:
(i) trapping metabolites in tissues;
(ii) producing an array of tissue sections;
(iii) contacting the array of tissue sections with a plurality of labeled probes for one or more metabolites;
(iv) imaging the tissue sections in the array to detect signals from the plurality of labeled probes;
(v) creating a mosaic of the images from the array and registering the signals from the plurality of labeled probes into a multispectral data set; and
(vi) analyzing the multi channel data set in N-dimensional data spaces using pattern recognition in order to generate a theme map representative of distinctive metabolites in a cell population within the tissue section.

12. The method of claim 11 further comprising:
(vii) displaying a visual indication of the theme maps or N-dimensional plot to visually indicate the distinctive metabolites in each cell population within the tissue section.

13. The method of claim 11, wherein the plurality of labeled probes are hapten-specific IgG reagents.

14. The method of claim 11, wherein the plurality of labeled probes are specific for one or more metabolites selected from the group consisting of: L-alanine, ADP, allantoin, allantoate, aminophosphonobutyrate, ATP, AGB, beta-alanine, L-Cysteine, cyclic AMP, cyclic GMP, D-aspartate, L-aspartate, dopamine, D-glutamate, L-glutamate, L-phenylalanine, glycine, D-glucosamine, carboxyglutamate, guanidinium, guanidoacetate, L-histidine, L-isoleucine, glutathione, L-lysine, L-leucine, L-lactic acid, L-methionine, L-asparagine, norepinephrine, L-ornithine, 2-oxoglutarate, L-proline, L-4-hydroxyproline, D-glutamine, L-glutamine, D-arginine, L-arginine, L-serine, serotonin, L-threonine, taurine, L-valine, L-tryptophan, L-citrulline, L-tyrosine, and GABA. Other metabolites may be included.

15. The method of claim 11, wherein the plurality of labeled probes are specific for one or more metabolites selected from the group consisting of: agmatine (1-amino, 4-guanidino butyrate), alanine, 4-aminobutyrate, arginine, aspartate, ATP, ADP, citrulline, cysteine, glutamate, glutamine, glutathione, glucosamine, glycine, guanidoacetate, ornithine, proline, phenylalanine, serine, taurine, threonine, and tyrosine.

16. (canceled)

17. (canceled)

18. A method for selecting one or more therapeutic agents for the treatment of a disease, the method comprising:
(a) obtaining a computational molecular phenotype (CMP) profile from a diseased tissue obtained from a subject;
(b) obtaining a CMP profile from a reference tissue;
(c) determining whether the CMP profile measured for the diseased tissue is different than the CMP profile from the reference tissue to detect one or more metabolic aberrancies in the diseased tissue; and
(d) selecting one or more therapeutic agents for the subject, wherein the agents reduce the difference that was detected in the CMP profile from the diseased tissue compared to the reference tissue.

19. A method of identifying one or more metabolic aberrancies resulting from a cellular response and selecting one or more therapeutic agents for the treatment of a disease, the method comprising:
(a) obtaining a computational molecular phenotype (CMP) profile from a diseased tissue obtained from a subject;
(b) obtaining a CMP profile from a reference tissue;
(c) determining whether the CMP profile measured for the diseased tissue is different than the CMP profile from the reference tissue to detect one or more metabolic aberrancies in the diseased tissue relating to: anaerobic metabolism, abnormal growth, apoptosis, cytoskeletal remodeling, altered gene transcription, motility, differentiation, proliferation, inflammation or angiogenesis;
(d) selecting one or more therapeutic agents for the subject, wherein the agents reduce the difference that was detected in the CMP profile from the diseased tissue compared to the reference tissue with respect to: anaerobic metabolism, abnormal growth, apoptosis, cytoskeletal remodeling, altered gene transcription, motility, differentiation, proliferation, inflammation or angiogenesis.

20. The method of claim 19, wherein the one or more metabolic aberrancies is the Warburg effect.

21. The method of claim 20, wherein the one or more therapeutic agents is selected from the group consisting of Imatinib, SB-204990, 2-deoxy-D-glucose (2DG), 3-bromopyruvate, 5-thioglucose, and dichloroacetic acid (DCA).

22. The method of claim 19, wherein the one or more therapeutic agents are selected based on one or more of
(a) prior success in reducing the one or more metabolic aberrancies; and
(b) relevant clinical or personal information from the individual;
wherein the relevant clinical or personal information comprises one or more of lifestyle, health, nutritional status, ethnic background, diet, age, sex, weight, current or past vitamin and/or drug regimes or treatments, medical conditions, and allergies.

23. (canceled)

24. (canceled)

25. (canceled)

26. (canceled)
